(19) United States
(12) Patent Application Publication
(10) Pub. No.: US 2013/0230108 A1
(43) Pub. Date: Sep. 5, 2013

(54) METHOD AND DEVICE FOR DECODING A BITSTREAM

(71) Applicant: CANON KABUSHIKI KAISHA, Tokyo (JP)

(72) Inventors: Fabrice Le LEANNEC, MOUAZE (FR); Sebastien LASSERRE, RENNES (FR)

(73) Assignee: CANON KABUSHIKI KAISHA, Tokyo (JP)

(21) Appl. No.: 13/779,312

(22) Filed: Feb. 27, 2013

(30) Foreign Application Priority Data
Mar. 2, 2012 (GB) 1203659.6

(51) Int. Cl. H04N 7/26

(52) U.S. Cl. CPC H04N 19/00939
USPC 375/240.16; 375/240.12

(57) ABSTRACT

A method and device for decoding a bitstream of encoded video data comprising a plurality of coding units, the method comprising: receiving the encoded video data; determining coding units missing from the received encoded video data, identifying further coding units dependent, for decoding according to a spatial prediction process, on the coding units determined as missing; treating a further coding unit of the identified further coding units as not being missing in the case where the majority of coding units on which it is dependent have been received and provide equal predictor values for the spatial prediction process, otherwise treating the further coding unit as missing.

This application claims the benefit of GB Patent Application No. 1203659.6, filed Mar. 2, 2012, which is hereby incorporated by reference herein in its entirety.

### FIELD OF THE INVENTION

The present invention concerns a method and a device for decoding a bistream comprising encoded video data.

The invention relates to the field of digital signal processing, and in particular to the field of video compression using motion compensation to reduce spatial and temporal redundancies in video streams.

### BACKGROUND OF THE INVENTION

Many video compression formats, such as for example H.263, H.264, MPEG-1, MPEG-2, MPEG-4, SVC, use block-based discrete cosine transform (DCT) and motion compensation to remove spatial and temporal redundancies. Such formats can be referred to as predictive video formats. Each frame or image of the video signal is divided into slices which are encoded and can be decoded independently. A slice is typically a rectangular portion of the frame, or more generally, a portion of a frame or an entire frame. Each slice is divided into portions referred to as macroblocks (MBs), and each macroblock is further divided into blocks, typically blocks of 8×8 pixels. The encoded frames are of two types: temporal predicted frames (either predicted from one reference frame called P-frames or predicted from two reference frames called B-frames) and non temporal predicted frames (called Intra frames or I-frames).

Temporal prediction consists in finding in a reference frame, either a previous or a future frame of the video sequence, an image portion or reference area which is the closest to the block to be encoded. This step is known as motion estimation. Next, the block is predicted using the reference area (motion compensation)—the difference between the block to be encoded and the reference portion is encoded, along with an item of motion information relative to the motion vector which indicates the reference area to use for motion compensation.

In order to further reduce the cost of encoding motion information, encoding a motion vector in terms of a difference between the motion vector and a motion vector predictor has been proposed. The motion vector predictor is typically computed from the motion vectors of the blocks surrounding the block to be encoded. In such a case only a residual motion vector is encoded in the bitstream representing the difference between the motion vector predictor and the motion vector obtained during the motion estimation process.

Scalable Video coding (SVC) involves the transmission of multi-layered video streams composed of scalability layers comprising a small base layer and optional additional layers that enhance resolution, frame rate and image quality. Layering provides a higher degree of error resiliency and video quality with no significant need for higher bandwidth. Additionally, a single multi-layer SVC video stream can support a broad a range of devices and networks.

A typical error resilient SVC decoder implementation aims to provide an error resilience tool that enables any SVC stream corrupted by packet losses that may occur during SVC network streaming for example. A typical error resilient SVC decoding process may include the processing steps as set out below.

A loss detection process loads coded SVC data corresponding to a Group of Pictures (GOP) i.e. a period of time separating two successive instantaneous decoder refresh (IDR) pictures. The loss detection step is able to identify full picture losses, together with the scalability layers where these picture losses take place.

The decoder then selects the scalability level to decode. All scalability layers from the base layer that do not contain any full picture loss are decoded. Ultimately, if a full picture loss is detected in the base layer, then only the base layer is decoded, and error concealment is used to recover the lost picture.

In the case where non complete pictures are lost, i.e. slices are lost, the decoder first identifies all macroblocks from all scalability layers that are impacted by the lost slice(s). A so-called “lost macroblock” marking process is employed for this purpose.

Once the lost macroblocks marking process is done, the decoder performs error concealment on lost macroblocks in the topmost scalability layer being decoded. This error concealment aims at limiting the visual impact of losses onto the visual quality of the reconstructed video sequence. Generally when a slice is lost, all macroblocks belonging to that slice are also marked as lost. Once this done, the CSVC decoder computes so-called inter-layer loss propagation and then intra-layer spatial loss propagation.

Inter-layer loss propagation, consists in the following: if a given layer (different from the topmost layer) contains lost macroblocks, then macroblocks of enhancement layers that would employ inter-layer prediction from these lost macroblocks are also marked as lost.

Intra-layer spatial loss propagation consists in the following: in any scalability layer, spatial prediction of INTRA macroblocks and spatial prediction of motion vector of INTER macroblocks is likely to propagate across neighboring macroblocks. Therefore, macroblocks which spatially depend on neighboring, already processed macroblocks, which have been marked as lost, are also marked as lost.

One known technique consists in marking a macroblock as lost when it spatially depends on a neighboring macroblock used for the prediction of current macroblock which is lost. With respect to motion vectors, in H.264/AVC and SVC, the motion vector of a given block is spatially predicted from the median motion vector of 3 spatially neighboring blocks. Therefore, if one of these three blocks is marked as lost, then it is no longer possible to compute the median value over the three motion vectors, and current block is also marked as lost leading to a significant spatial propagation of lost macroblocks.

This technique leads to a significant spatial propagation of loss across the macroblocks contained in a given slice. In practice, the motion vector predictive coding is such that once an INTER macroblock is marked as lost in a slice, then all subsequent macroblocks in the slice are very likely to be marked as lost as well.

Examples of SVC error resilience and SVC error concealment which are part of a typical error resilient SVC decoder are illustrated in FIGS. 1a and 1b. The overall error resilience and concealment process is set out as follows. Firstly a loss detection process comprises detecting the loss of entire pictures or the loss of slices from a received bitstream. When a picture or slice loss is detected, an appropriate error concealment operation is applied based on the detected loss. The error concealment operation includes selecting an appropriate scalability layer to decode according to the lost pictures. With respect to slice losses, another concealment mechanism is invoked when a slice is lost, as described in what follows.

A first error resilience tool that is used by an exemplary robust SVC decoder involves the detection of complete picture loss. The detection of complete picture loss is graphically illustrated in FIG. 1a. The process deletes the entire uppermost layer of the GOP (time period between two successive IDR pictures), if some losses are detected in this layer. The process thereby ensures that all layers in the GOP that are provided to the actual decoding process are complete, except for the base layer that may still contain lost pictures. In the latter case, all the upper layers are deleted and the base layer is decoded and concealed.

The picture loss detection process consists in loading all (network abstract layer) NAL units belonging to a same GOP. Then, by virtue of the scalability information contained in the NAL unit headers, the decoder is able, through a simple NAL unit header analysis, to count the total number of pictures received in each layer in the current considered GOP. The first GOP is used to teach the GOP structure of the sequence. The 3 main cases that may occur, which are graphically illustrated by FIG. 1a, are as follows:

1. If the uppermost layer is not complete, then it is deleted.

2. If an intermediate layer, different from the base layer and from the uppermost layer, is not complete then the all layers from the intermediate layer up to the uppermost layer are deleted.

3. If the base layer is not complete, then all upper layers are deleted.

Complete lost pictures are managed by means of a high level NAL unit header analysis over a time period corresponding to a GOP. Moreover, a SVC layer switching process follows the picture loss detection, and aims at selecting the scalability level that will be processed by the decoder afterwards. In the first GOP illustrated in FIG. 1a no pictures are missing from the uppermost layer, no pictures are missing from the intermediate layer or base layer thus and the upper layer may be decoded. In the second GOP two pictures are missing from the uppermost layer no pictures are missing from the intermediate layer or base layer thus the intermediate layer may be decoded. In the third GOP three pictures are missing from the uppermost layer, two pictures are missing from the intermediate layer and one picture is missing from the base layer. In this case the base layer may be decoded.

FIG. 1b graphically illustrates the overall decoding process performed by a typical C-SVC decoder in the case of slice losses in a scalable SVC stream. As illustrated, the decoder no longer switches between layers in the case where only a part of a picture is lost. On the contrary, the upper most layer is decoded in such a case. In the case of FIG. 1b, when decoding the uppermost layer, some macroblocks in the uppermost layer may use some lower layer macroblocks as reference data for their inter-layer prediction (ILP). Therefore, in the case where the reference data for ILP is lost, the uppermost macroblock cannot be properly decoded. Hence there is a need for an SVC specific loss detection process that takes into account inter-layer dependencies.

An example of a slice loss detection process of the prior art is schematically illustrated in FIG. 2 for a multilayered video stream having a base layer and two enhancement layers. The overall macroblock decoding process applied includes three main decoding steps: syntactic decoding (referred to herein as parsing), a decoding step (which includes temporal/spatial prediction, inverse DCT, inverse quantization and addition of a residual to block temporal/spatial predictor) and a deblocking filtering step. The deblocking step is not shown in FIG. 2.

A fast SVC decoder typically runs the parsing of different scalability layers in parallel, while the decoding of a scalability representation of a given picture can only be done once the lower layers have been decoded.

As a consequence of this typical SVC parsing/decoding architecture, a specific, two-step, loss detection process is performed for SVC scalable bitstreams. This consists in progressively marking macroblocks as lost or received as follows.

Firstly, before starting processing of a given picture, all macroblocks in the picture are marked as ILP_LOST and unmarked MB_LOST.

Next, the scalability layers of the considered picture are parsed in parallel. During the parsing process, each received macroblock in the considered scalability layers is unmarked ILP_LOST. When a NAL unit containing a slice happens to be truncated, then the macroblock that was expected by the slice parsing process is marked as MB_LOST.

As a result of the parsing process, all macroblocks received in a scalability layer are unmarked ILP_LOST. The decoding process then relies on this ILP_LOST marking process. To do so, each SVC inter-layer prediction function (residue, texture, and motion vectors) checks if the reference macroblock in the base layer is available, i.e. unmarked ILP_LOST. In the case where the reference macroblock is lost, the decoding of the current macroblock is stopped and the current macroblock in the enhancement layer is marked as both ILP_LOST and MB_LOST (right side of FIG. 2).

Finally, during the deblocking filtering process, the macroblocks marked as MB_LOST macroblocks undergo an error concealment process, which aims at minimizing the visual impact of the loss on the reconstructed and displayed corrupted macroblocks. Once this error concealment has been applied on lost macroblocks in the topmost layer, the resulting decoded picture undergoes a deblocking filtering process.

As a result of the ILP_LOST and MB_LOST macroblock type assignment presented above, some macroblocks in the uppermost layer are marked as MB_LOST. The loss of a macroblock in an enhancement layer slice may, however, propagate in the concerned slice since a macroblock may be predicted from its spatially neighbouring macroblocks, through any of the following H.264/SVC spatial prediction mechanisms.
Motion vector (MV) spatial prediction
Direct spatial prediction of motion vector for skipped macroblocks
Spatial prediction of INTRA macroblocks: can be limited through constrained INTRA prediction on the encoder side.

Therefore, when trying to decode and reconstruct a macroblock in the uppermost layer, it is verified as to whether or not one of the reference macroblocks used to spatially predict the current macroblock has been lost, i.e. if the reference macroblock is marked as MB_LOST. In the devices of the prior art previously described if one of the reference macroblocks is determined as lost the current macroblock is also marked as MB_LOST. This loss marking propagation is illustrated in FIG. 3a. In this figure, blocks of the second slice representing the second line of blocks in the base layer image, are lost. 2 blocks in the enhancement layer image are predicted from the base layer using ILP: block at position (b,2) and block at position (g,2). These two blocks are marked as lost. Due to error propagation, for instance for dependencies induced by motion vector prediction or intra prediction, blocks in enhancement image at position (c,2), (d,2), (e,2), (h,2) and all blocks in the third line are also marked as lost.

As an example, the result obtained by applying such inter-layer and spatial dependency analysis of the prior art to mark lost macroblocks is illustrated on the right side of FIG. 3b. The left hand of FIG. 3b shows the decoded picture obtained with marked MB_LOST macroblocks, when losing one slice in the uppermost layer of a two layer SVC stream. In this case, all of the macroblocks in the slice are marked as ILP_LOST and then as MB_LOST during the decoding process. The right side of FIG. 3b shows the result obtained when a slice is lost in the base layer and deterioration of the image quality.

### SUMMARY OF THE INVENTION

The present invention has been devised to address one or more of the foregoing concerns.

According to a first aspect of the invention there is provided a method of decoding a bitstream of encoded video data comprising a plurality of coding units, the method comprising: receiving the encoded video data; determining coding units missing from the received encoded video data; identifying further coding units dependent, for decoding according to a spatial prediction process, on the coding units determined as missing; treating a further coding unit of the identified further coding units as not being missing in the case where a majority of coding units on which it is dependent have been received and provide equal spatial predictor values for the spatial prediction process, otherwise treating the further coding unit as missing.

Accordingly fewer macroblocks of the video bitstream are considered as being lost and spatial propagation of lost macroblocks is reduced thereby leading to improved image quality in the case where macroblocks of the video bitstream are not received by a decoder.

For example, the further coding unit is dependent on three coding units and the further coding unit is treated as not being missing when two of the three coding units on which it is dependent have been received.

In an embodiment the step of determining coding units missing from the received encoded video data comprises determining slices of data missing from the received encoded data and determining the missing coding units based on the slices determined as missing.

In one or more embodiments of the invention the method includes setting a spatial predicted value of the further coding unit treated as not missing to the equal spatial predictor value provided by the two coding units on which the further coding unit is dependent.

The method may be performed during a syntactic decoding process.

In an embodiment, the spatial predictor value comprises a motion vector value for a motion vector prediction process.

In an embodiment the method includes performing an error concealment process on the coding units and further coding units treated as missing.

In an embodiment the video data has been encoded according to a scalable video coding process and comprises a plurality of scalable layers wherein inter-layer dependencies between coding units are taken into account when identifying further coding units dependent on a missing coding unit.

In an embodiment the method includes selecting a scalability layer for decoding based on the coding units detected as missing.

According to a second aspect of the invention there is provided a decoding device for decoding a bitstream of encoded video data comprising a plurality of coding units, the decoding device comprising: means for receiving the encoded video data; means for determining coding units missing from the received encoded video data; means for identifying further coding units dependent, for decoding according to a spatial prediction process, on the coding units determined as missing; means for treating a further coding unit of the identified further coding units as not being missing in the case where a majority of the coding units on which it is dependent have been received and provide equal spatial predictor values for the spatial prediction process, otherwise treating the further coding unit as missing.

For example, the further coding unit is dependent on three coding units and the further coding unit is treated as not being missing when two of the three coding units on which it is dependent have been received.

In an embodiment the step of determining coding units missing from the received encoded video data comprises determining slices of data missing from the received encoded data and determining the missing coding units based on the slices determined as missing.

In an embodiment the device includes means for setting a spatial predicted value of the further coding unit treated as not missing to the equal spatial predictor value provided by the two coding units on which the further coding unit is dependent.

In an embodiment the device is operable to perform during a syntactic decoding process.

In an embodiment, the spatial predictor value comprises a motion vector value for a motion vector prediction process.

In an embodiment, means are provided for performing an error concealment process on the coding units and further coding units treated as missing.

In an embodiment, the video data has been encoded according to a scalable video coding process and comprises a plurality of scalable layers wherein inter-layer dependencies between coding units are taken into account by the means for identifying further coding units dependent on a missing coding unit.

In an embodiment, means are provided for selecting a scalability layer for decoding based on the coding units detected as missing.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible carrier medium may comprise a storage medium such as a floppy disk, a CD-ROM, a hard disk drive, a magnetic tape device or a solid state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Embodiments of the invention will now be described, by way of example only, and with reference to the following drawings in which:

FIG. 1a graphically illustrates an example of picture loss detection and SVC layer switching;

FIG. 1b graphically illustrates an example of slice loss detection and concealment;

FIG. 2 illustrates an example of a slice loss detection process of the prior art comprising a macroblock marking procedure;

FIGS. 3a and 3b illustrate examples of slice losses in SVC processes of the prior art;

FIG. 4 is a schematic diagram of a wireless communication network in which one or more embodiments of the invention may be implemented;

FIG. 5 is a schematic block diagram of a wireless communication device according to at least one embodiment of the invention;

FIG. 6 is a schematic block diagram of a H.264/AVC decoder;

FIG. 7 is a schematic block diagram of a SVC decoder in which one or more embodiments of the invention may be implemented;

FIG. 8 is a schematic illustration of a method of using motion vector prediction for a macroblock having neighbouring macroblocks in accordance with an embodiment of the invention;

FIG. 9 graphically illustrates PSNR curves obtained by applying an embodiment of the invention;

FIG. 10 are images obtained by applying a) the prior art and b) an embodiment of the invention;

FIG. 11 is a flow chart illustrating steps of a decoding method according to at least one embodiment of the invention;

FIG. 12 is a flow chart illustrating steps of a prediction decoding process in accordance with an embodiment of the invention; and

FIG. 13 is a flowchart illustrating steps of a method for decoding a bitstream in accordance with an embodiment of the invention.

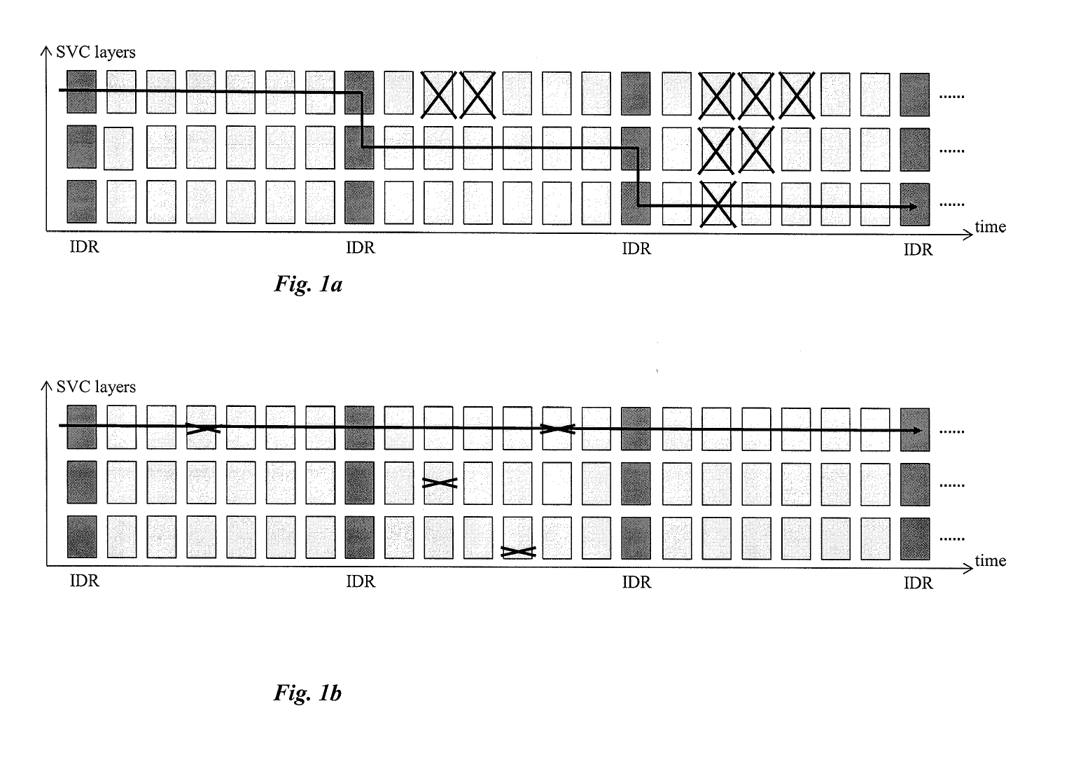

### DETAILED DESCRIPTION OF THE DRAWINGS

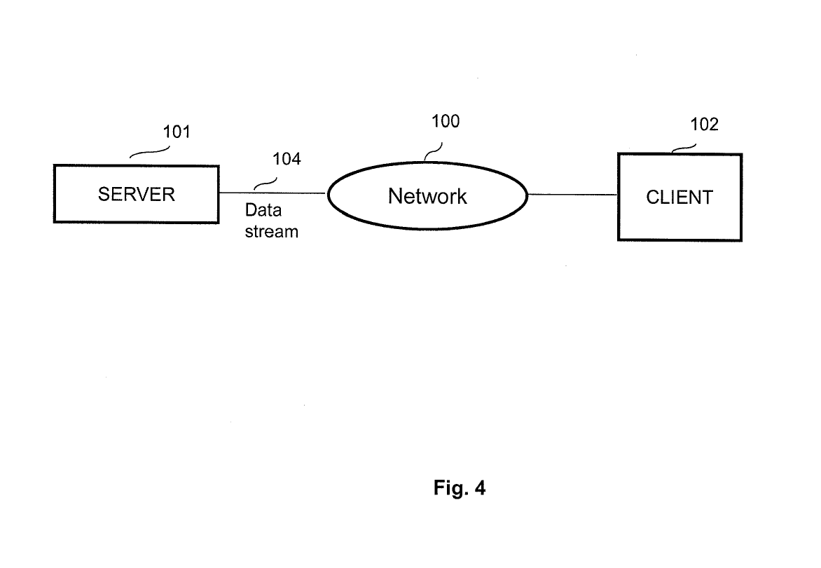

FIG. 4 illustrates a data communication system in which one or more embodiments of the invention may be implemented. Although a streaming scenario is considered here, it will be appreciated that in alternative embodiments of the invention the data communication can be performed using for example a media storage device such as an optical disc or a solid state memory device. The data communication system comprises a transmission device, in this case a server 101, which is operable to transmit data packets of a data stream to a receiving device, in this case a client terminal 102, via a data communication network 100. The data communication network 100 may be a Wide Area Network (WAN) or a Local Area Network (LAN). Such a network may be for example a wireless network (Wifi/802.11a or b or g), an Ethernet network, an Internet network or a mixed network composed of several different networks. In a particular embodiment of the invention the data communication system may be a digital television broadcast system in which the server 101 sends the same data content to multiple clients.

The data stream 104 provided by the server 101 may be composed of multimedia data representing video and audio data. Audio and video data streams may, in some embodiments of the invention, be captured by the server 101 using a microphone and a camera respectively. In some embodiments data streams may be stored on the server 101 or received by the server 101 from another data provider, or generated at the server 101. The server 101 is provided with an encoder for encoding video and audio streams in particular to provide a compressed bitstream for transmission that forms a more compact representation of the data presented as input to the encoder.

The client 102 receives the transmitted bitstream and decodes the reconstructed bitstream to reproduce video images on a display device and the audio data by a loud speaker.

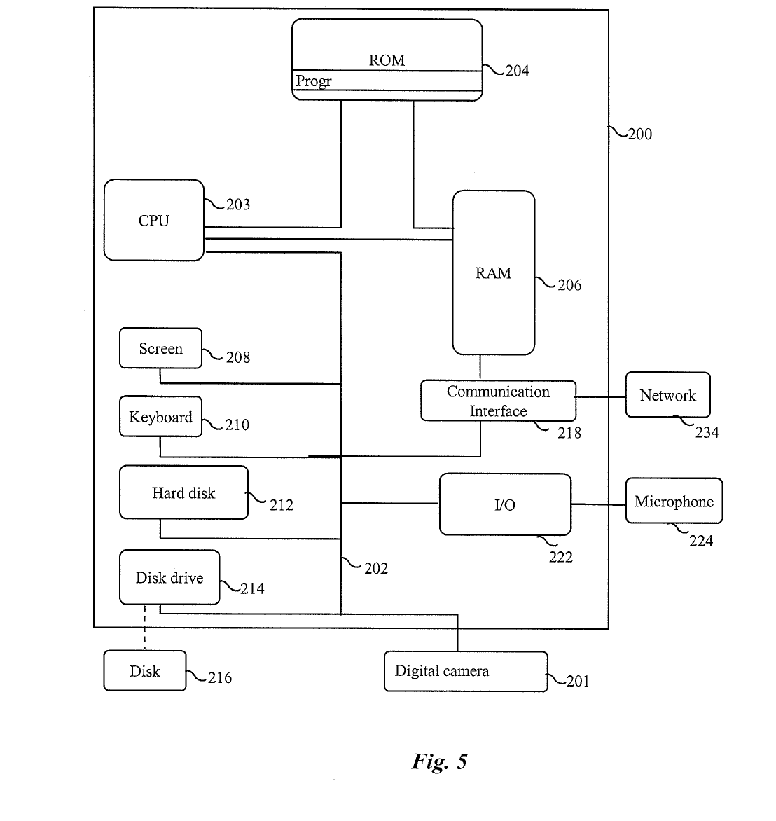

FIG. 5 schematically illustrates a processing device 200 configured to implement at least one embodiment of the present invention. The processing device 200 may be a device such as a micro-computer, a workstation or a light portable device. The device 200 comprises a communication bus 202 to which there are preferably connected:
a central processing unit 203, such as a microprocessor, denoted CPU;
a read only memory 204, denoted ROM, for storing computer programs for implementing the invention;
a random access memory 206, denoted RAM, for storing the executable code of the method of embodiments of the invention as well as the registers adapted to record variables and parameters necessary for implementing the method of encoding a sequence of digital images and/or the method of decoding a bitstream according to embodiments of the invention; and
a communication interface 218 connected to a communication network 234 over which digital data to be processed are transmitted.

Optionally, the apparatus 200 may also include the following components:
a data storage means 212 such as a hard disk, for storing computer programs for implementing methods of one or more embodiments of the invention and data used or produced during the implementation of one or more embodiments of the invention;
a disk drive 214 for a disk 216, the disk drive being adapted to read data from the disk 216 or to write data onto said disk;
a screen 208 for displaying data and/or serving as a graphical interface with the user, by means of a keyboard 210 or any other pointing means.

The apparatus 200 can be connected to various peripherals, such as for example a digital camera 201 or a microphone 224, each being connected to an input/output card (not shown) so as to supply multimedia data to the apparatus 200.

The communication bus provides communication and interoperability between the various elements included in the apparatus 200 or connected to it. The representation of the bus is not limiting and in particular the central processing unit is operable to communicate instructions to any element of the apparatus 200 directly or by means of another element of the apparatus 200.

The disk 216 can be replaced by any information medium such as for example a compact disk (CD-ROM), rewritable or not, a ZIP disk or a memory card and, in general terms, by an information storage means that can be read by a microcomputer or by a microprocessor, integrated or not into the apparatus, possibly removable and adapted to store one or more programs whose execution enables the method of encoding a sequence of digital images and/or the method of decoding a bitstream according to the invention to be implemented.

The executable code may be stored either in the read only memory 204, on the hard disk 212 or on a removable digital medium such as for example a disk 216 as described previously. According to a variant, the executable code of the programs can be received by means of the communication network 34, via the interface 218, in order to be stored in one of the storage means of the apparatus 200 before being executed, such as the hard disk 212.

The central processing unit 203 is adapted to control and direct the execution of the instructions or portions of software code of the program or programs according to the invention, instructions that are stored in one of the aforementioned storage means. On powering up, the program or programs that are stored in a non-volatile memory, for example on the hard disk 212 or in the read only memory 204, are transferred into the random access memory 206, which then contains the executable code of the program or programs, as well as registers for storing the variables and parameters necessary for implementing the invention.

In this embodiment, the apparatus is a programmable apparatus which uses software to implement the invention. However, alternatively, the present invention may be implemented in hardware (for example, in the form of an Application Specific Integrated Circuit or ASIC).

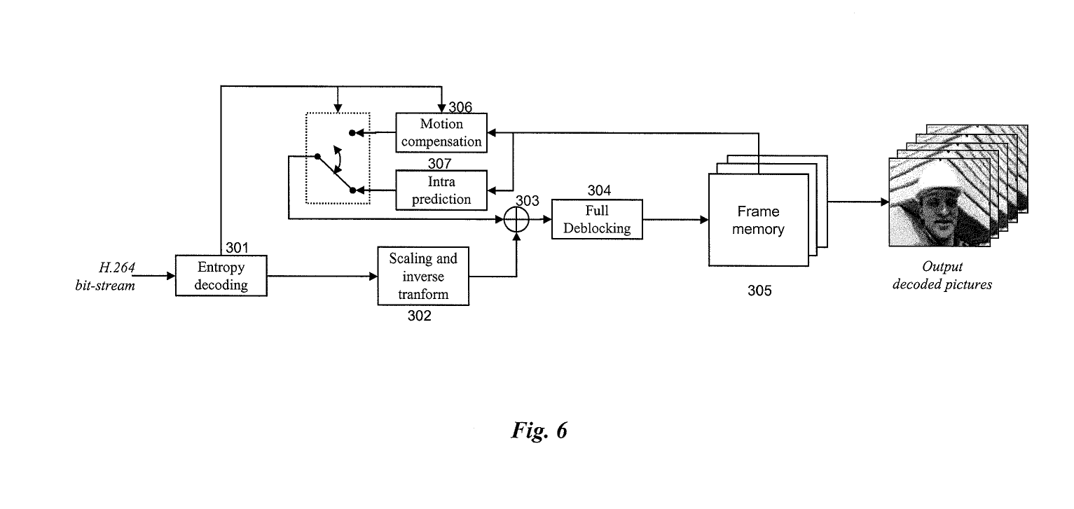

FIG. 6 is a schematic block diagram of a H.264/AVC decoding device according to at least one embodiment of the invention. The decoding device comprises an entropy decoding module 301 for performing entropy decoding of each macroblock (16×16 pixels) of each coded picture in a received H.264 bitstream. The entropy decoding module 301 provides a coding mode, motion data (reference pictures indexes, motion vectors of INTER coded macroblocks) and residual data. The residual data consists in quantized and transformed DCT coefficients. Next the quantized DCT coefficients undergo an inverse quantization and inverse transform operation performed by a scaling and inverse transform module 302. The decoded residual is then added by an adder 303 to the temporal or INTRA prediction macroblock of the current macroblock provided respectively by motion compensation module 306 and intra prediction module 307, to provide a reconstructed macroblock. The reconstructed macroblock then undergoes a so-called de-blocking filtering process performed by full deblocking module 304, which aims at reducing the blocking artifact inherent to any block-based video codec. The full de-blocked picture is then stored in the Decoded Picture Buffer (DPB), represented by the frame memory 305 in FIG. 5, which stores images that will serve as references for predicting future images to be decoded. The decoded images are also ready to be displayed on a screen if so desired. Embodiments of the present invention relate to the implementation of the de-blocking filtering process in a parallelized H.264/AVC software decoder.

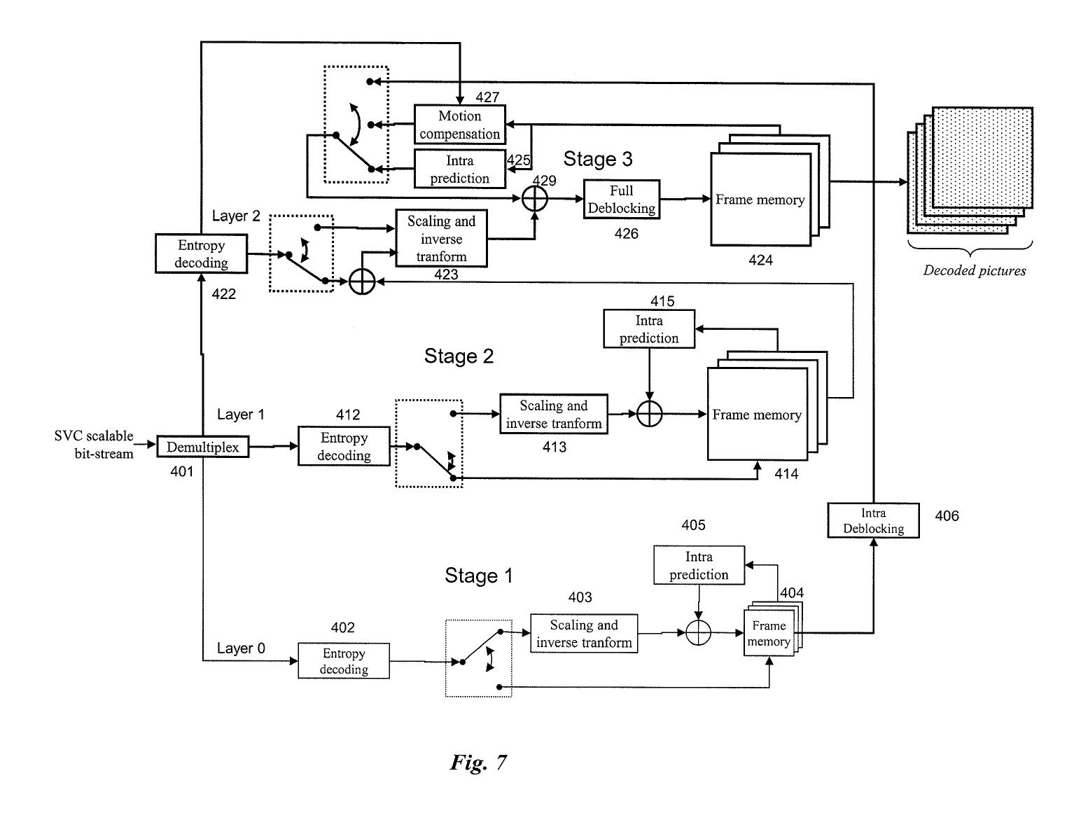

FIG. 7 is a schematic block diagram of a SVC decoding process according to an embodiment of the invention that may be applied to a SVC bitstream including 3 scalability layers. More precisely, the SVC stream being decoded in FIG. 7 is made up of a base layer, a spatial enhancement layer, and a SNR enhancement layer above the spatial layer.

The SVC scalable bitstream is received and demultiplexed by a demultiplexer module 401. An initial stage of the process involves decoding of the base layer. The base layer decoding process starts with entropy decoding by an entropy decoding module 402 of each macroblock (array of pixels) of each coded picture in the base layer. The entropy decoding provides a coding mode, motion data (reference pictures indexes, motion vectors of INTER coded macroblocks) and residual data. The residual data comprises quantized and transformed DCT coefficients. Next, the quantized DCT coefficients undergo an inverse quantization and transform operation by a scaling and inverse transform module 403, in the case where the upper layer has a higher spatial resolution than the current one. The second layer of the bit-stream has a higher spatial resolution than the base layer. Consequently, inverse quantization and transform is activated in the base layer. Indeed, in SVC, the residual data is completely reconstructed in layers that precede a resolution change, because the texture data has to undergo a spatial up-sampling process. On the contrary, the inter layer prediction and texture refinement process is applied directly on quantized coefficients in the case of a quality enhancement layer.

The so-reconstructed residual data is then stored in a frame memory buffer 404. Moreover, INTRA-coded macroblocks are fully reconstructed by the application of well-known spatial intra prediction techniques by an intra-prediction module 405. Next, the decoded motion and temporal residual for INTER macroblocks, and the reconstructed INTRA-macroblock are stored in the frame memory buffer 404 in stage 1 of the SVC decoder of FIG. 7. The frame memory buffer 404 contains the data that can be used as reference data to predict an upper scalability layer.

Moreover, the inter layer prediction process of SVC applies a so-called intra-de-blocking operation by an intra deblocking module 406 on reconstructed INTRA macroblocks from the base layer of FIG. 7. The intra-de-blocking process comprises filtering the blocking artifacts that may appear at the frontiers of reconstructed INTRA macroblocks. The intra-de-blocking operation occurs in the inter-layer prediction process only when a spatial resolution change occurs between two successive layers. This is the case between layer 0 and layer 1 in FIG. 5.

Next, the second stage of FIG. 7 performs the decoding of a spatial enhancement layer above the base layer decoded by the first stage. The decoding of the spatial enhancement layer involves entropy decoding of the second layer by an entropy decoding module 412, which provides motion information as well as the transformed and quantized residual information of macroblocks of the second layer. With respect to INTER macroblocks, since the next layer (the third layer) has the same spatial resolution as the second one, the residual data of the INTER macroblocks only undergoes the entropy decoding step and the result is stored in the frame memory buffer 414 associated with the second layer of FIG. 7. Indeed, the residual texture refinement process is performed in the transform domain between SNR (CGS or MGS) layers in SVC.

The processing of INTRA macroblocks depends on the type of INTRA macroblocks. In the case of inter-layer predicted INTRA macroblocks (I_BL coding mode), the result of the entropy decoding is stored in the frame memory buffer 414. In the case of a non I_BL INTRA macroblock, such a macroblock is fully reconstructed, through inverse quantization and inverse transformation by scaling and inverse transform module 413 to obtain the residual data in the spatial domain, and then undergoes an INTRA prediction process by intra prediction module 415 to obtain the fully reconstructed macroblock.

Finally, the decoding of the third layer of FIG. 7, which also forms the uppermost layer of the considered stream, involves a motion compensated temporal prediction loop. The following successive steps are performed by the decoder to decode the sequence at the uppermost layer. Each macroblock firstly undergoes an entropy decoding process by an entropy decoding module 422, which provides motion and texture residual data. If inter-layer residual prediction data is used for the current macroblock, then the quantized residual data is used to refine the quantized residual data issued from the reference layer. Indeed, texture refinement is performed in the transform domain between layers that have the same spatial resolution. Then, an inverse quantization and transform is applied by a scaling and inverse transform module 423 on the optionally refined residual. This process provides reconstructed residual data. In the case of INTER macroblocks, the decoded residual refines the decoded residual issued from the base layer if the inter-layer residual prediction was used to encode the second scalability layer. In the case of an INTRA macroblock, the decoded residual is used to refine the prediction of the current macroblock. If the current macroblock is I_BL, then the decoded residual can be used to further refine the residual of the base macroblock, if it was coded in I_BL mode. The decoded residual is then added to the temporal, INTRA or inter-layer INTRA prediction macroblock of the current macroblock by an adder 429, to provide the reconstructed macroblock. An inter-layer INTRA prediction process is applied by an intra prediction module 425 in the case of I_BL INTRA macroblocks of the topmost layer, and consists in adding the decoded residual to the inter-layer intra prediction of the current macroblock in the spatial domain, issued from the base layer in the case of FIG. 7. The reconstructed macroblock finally undergoes a so-called full de-blocking filtering process by a full deblocking module 426, which is both applied on INTER and INTRA macroblocks, as opposed to the de-blocking filter applied in the base layer. The full deblocked picture is then stored in the Decoded Picture Buffer (DPB) (represented by the frame memory 424 in FIG. 7 which is used to store pictures that will be used as references to predict future pictures to be decoded. The decoded pictures are also ready to be displayed on screen, as illustrated by FIG. 7.

For the purposes of explanatory illustration in the examples which follow, the term inter-layer loss propagation is used to designate an MB_LOST macroblock marking process according to inter-layer dependencies. Intra-layer spatial loss propagation corresponds to the MB_LOST macroblock marking process as a function of spatial dependencies within a slice in an enhancement layer.

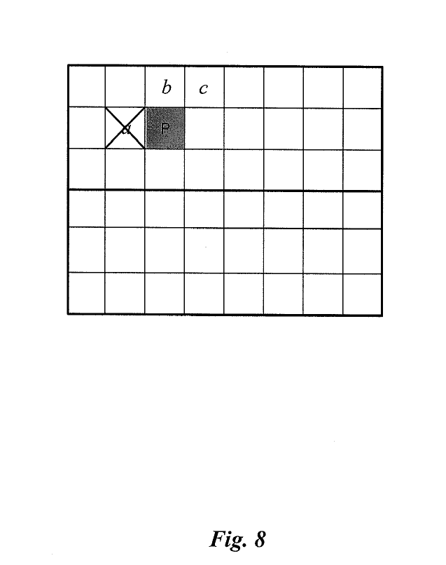

FIG. 8 illustrates a method of decoding a bitstream in accordance with an embodiment of the invention for improving the basic spatial loss propagation of motion information of INTER macroblocks. With respect to motion vectors, in H.264/AVC and SVC, the motion vector of a given macroblock is spatially predicted from the median motion vector of 3 spatially neighboring macroblocks, referred to as a, b and c as illustrated in FIG. 8

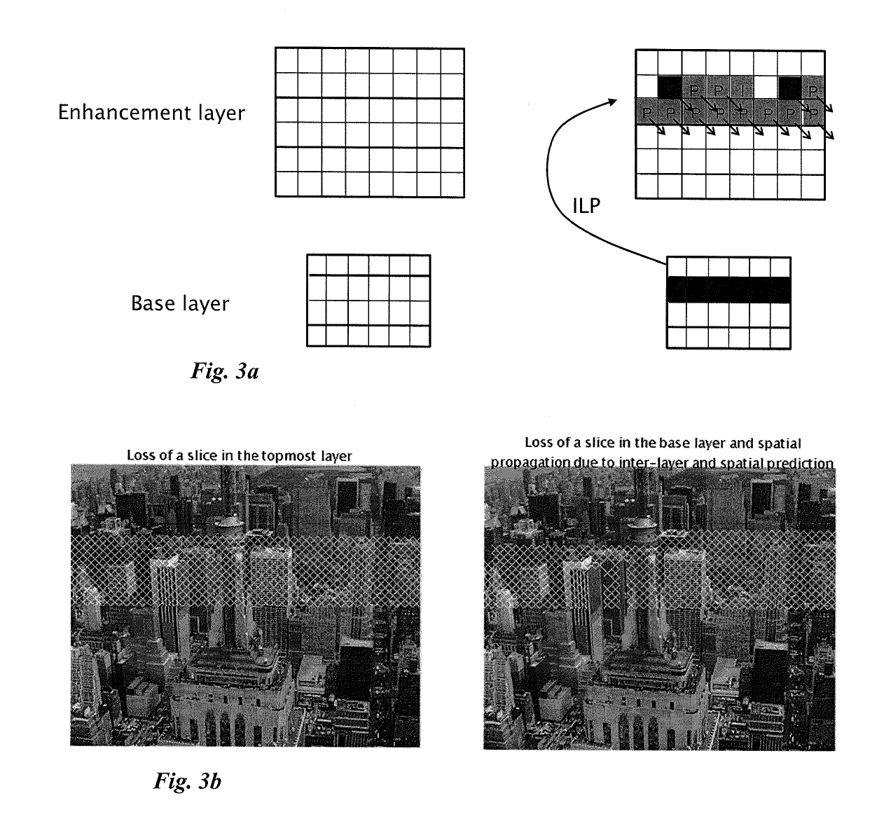

If one of the three neighbouring macroblocks a, b or c, is marked as lost in devices of the prior art, it is no longer possible to compute the median value of the three motion vectors, and the current macroblock P is marked as being lost. Such an approach leads to a significant spatial propagation of a loss across the macroblocks contained in a given slice. In practice, motion vector predictive coding is such that once an INTER macroblock is marked as lost in a slice, then all subsequent macroblocks in the slice are very likely to be also marked as lost as well (as previously illustrated by FIG. 3b).

The method according to embodiments of the invention on the contrary enables limiting the spatial propagation of lost macroblocks. The method is based on the following observation made by the inventors. When the decoder tries to spatially predict the motion vector of a given macroblock, if only one of the three neighboring macroblocks useful for MV prediction is lost, and the two other neighbouring macroblocks have equal motion vectors values, then the value of the motion vector predictor of the current macroblock is equal to the value of the two received macroblocks. Based on this observation, the spatial propagation of lost motion vectors can be limited, since some macroblocks which otherwise would have been marked as lost are marked as being received despite having lost spatially neighbors. This improved strategy to handle spatial propagation of lost macroblocks can be summarized by the following steps:

If neighbouring macroblock a, b or c of current macroblock P is lost
If current macroblock P is not located at the top border of its slice and:
   If a is lost but b and c are received and the value of motion vector MV_{b} of macroblock b is equal to the value of motion vector MV_{c} of macroblock c then the value of the motion vector predictor of macroblock P MVₚ₌MV_{b=}MV_{c}
   If b is lost but a and c are received and the value of motion vector MVₐ of macroblock a is equal to the value of motion vector MV_{c} of macroblock c then the value of the motion vector predictor of macroblock P MVₚ₌MVₐ₌MV_{c}
   If c is lost but a and b are received and the value of motion vector MVₐ of macroblock a is equal to the value of motion vector MV_{b} of macroblock b then the value of the motion vector predictor of macroblock P MVₚ₌MVₐ₌MV_{b}
   Else
Mark current macroblock P as being lost

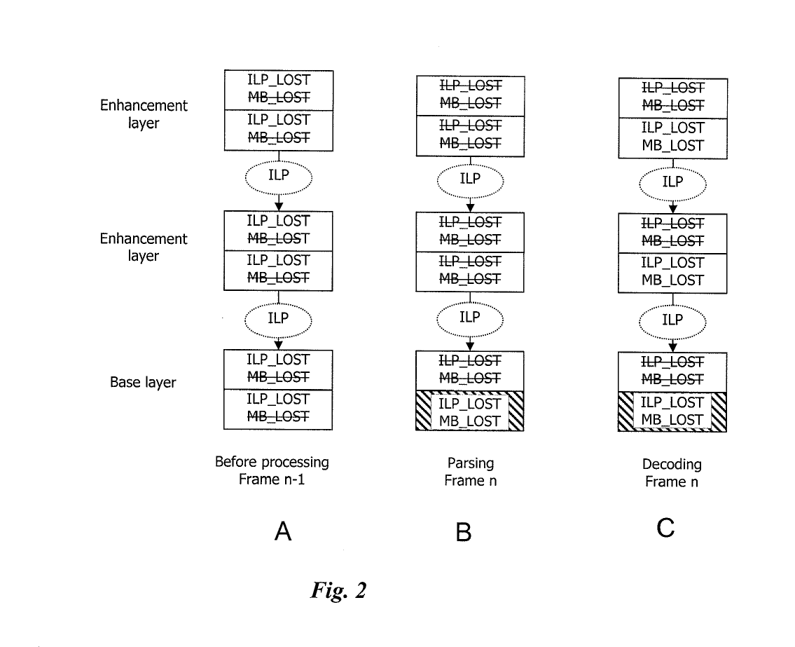

It may be noted that the proposed improved spatial propagation of macroblock losses is typically part of the SVC decoder step that is applied to reconstruct the motion vector of successive macroblocks in a given enhancement layer's coded slice. In a particular embodiment of the invention considered here, the motion vector reconstruction may be part of the parsing step described above with reference to FIG. 2.

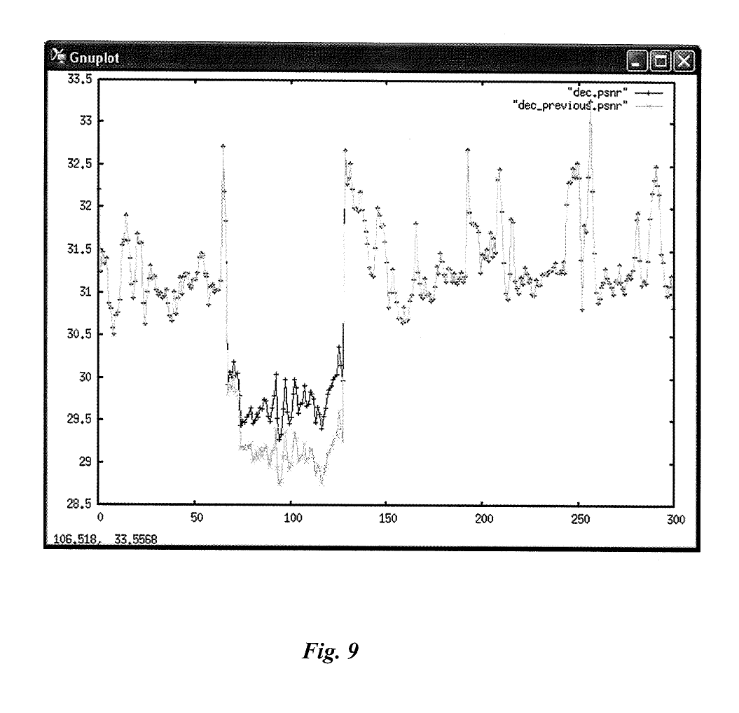

Improvement in restriction of propagation loss in embodiments of the invention is illustrated, as an example, by the Peak Signal to Noise Ratio (PSNR) curves of FIG. 9. The experiments of FIG. 9 consisted in generating some slice loss in a picture of the base layer of a two layered SVC stream with spatial scalability. The corrupted stream was then decoded with and without the spatial loss propagation strategy in accordance with embodiments of the invention described above. FIG. 9 demonstrates that the proposed method according to embodiments of the invention provides a better reconstructed picture in the picture where the loss happens, and then this difference propagates to the next IDR picture because of temporal prediction.

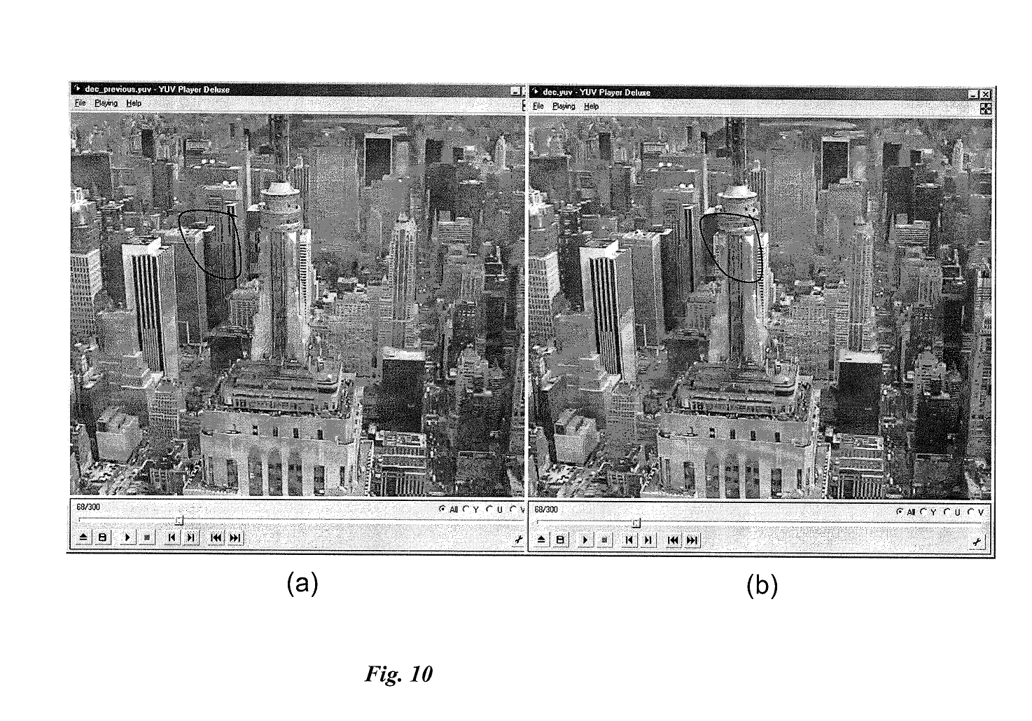

The reconstructed picture quality is also improved when using the methods of embodiments of the invention for limiting spatial loss propagation, as illustrated by the two reconstructed pictures of FIG. 10. The areas highlighted in FIG. 10 (a) show an erroneous block obtained when the proposed method of embodiments of the invention is not applied. The corresponding picture block in FIG. 10(b) are properly rendered by virtue of the proposed spatial propagation method.

Finally, it may be noted that the proposed methods of embodiments of the invention for limiting spatial loss propagation mechanism as herein described is applicable in the case of SVC, when inter-layer prediction is activated and when some slices in scalability layers lower than the topmost layer are lost.

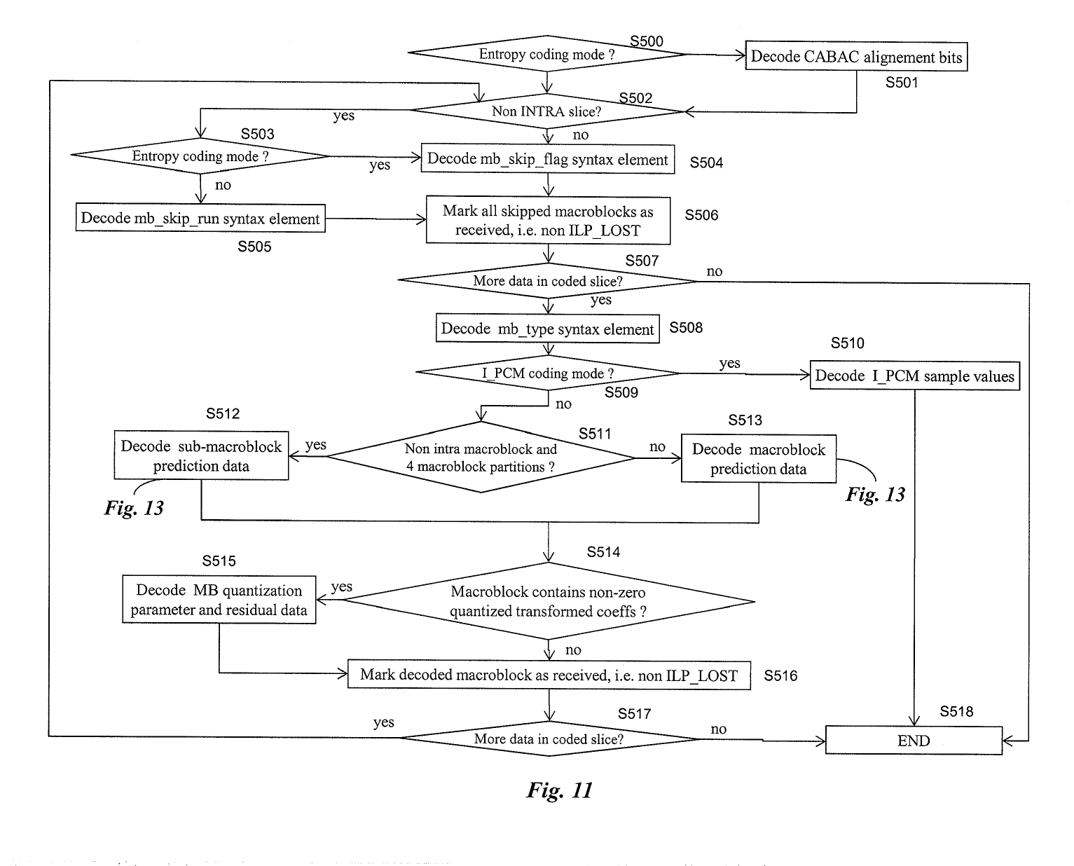

FIG. 11 is a flow chart illustrating steps of a decoding method according to at least one embodiment of the invention, and depicts an overall SVC image decoding process, as specified by the SVC compression standard. This overall picture decoding process includes a loop on all macroblocks contained in the coded picture, and in the decoding of each of these macroblocks. It should be noted that in this exemplary picture, slices are not illustrated for simplicity and clarity matters and it is considered that the coded picture contains exactly one slice.

In initial step S500 the entropy coding mode is determined in order to decide whether or not to include S501 in which CABAC alignment bits are decoded. In step S502 it is determined if the slice being processed is a non INTRA slice.

The algorithm includes parsing the syntax element indicating one or more skipped macroblocks. The syntax element in this embodiment takes the form of a “mb_skip_flag” (S504) or an “mk_skip_run” syntax element (S505), depending on the type of entropy coder used (S503) and on the type of current coded slice. Each macroblock for which the skip mode indicator is decoded is marked “non ILP_LOST” in step S506 signifying that the macroblock has been received (since it is contained in the current slice).

Step S507 involves testing if further macroblocks are contained in current coded slice. If no further macroblocks are contained in the current coded slice, the process of FIG. 11 comes to an end in step S518.

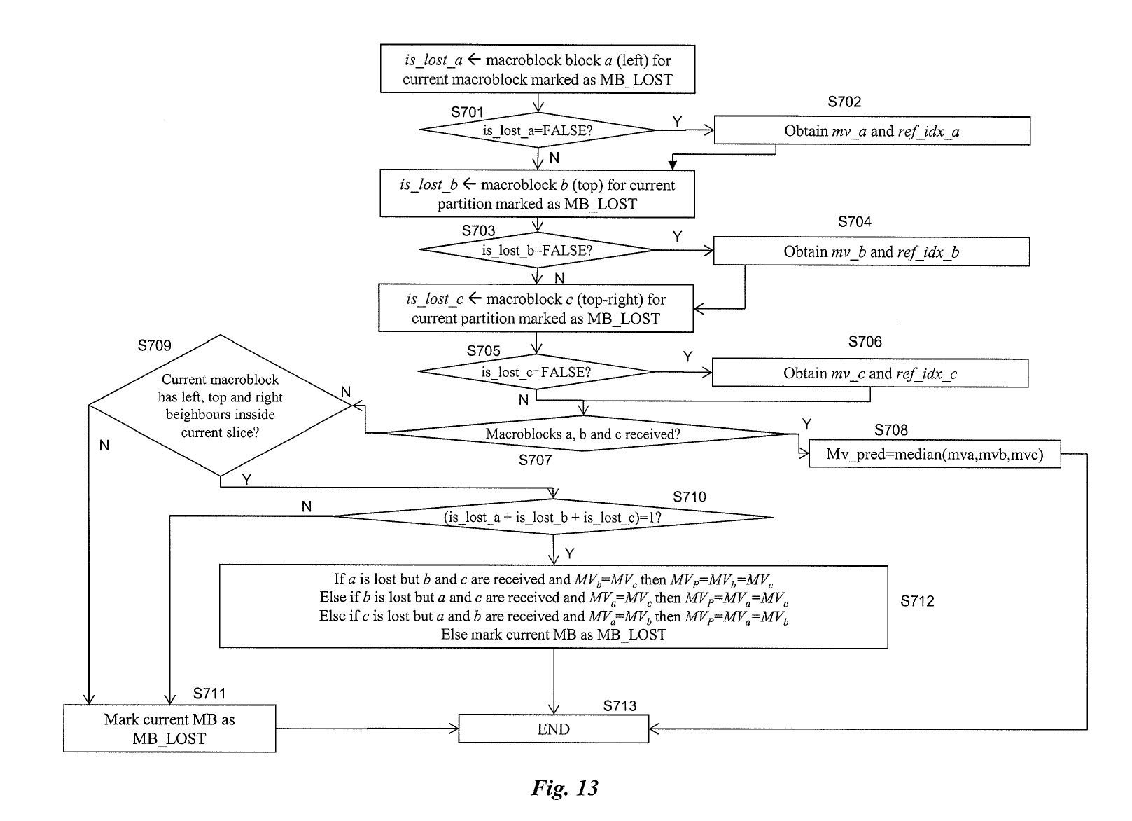

Otherwise if it is determined that there are further macroblocks, the next macroblock contained in the slice is not in SKIP mode. The algorithm then involves decoding this non skipped macroblock. First, at step S508, a syntax element indicating the type of current macroblock is decoded. This type may be INTRA, INTER, or I_PCM, which corresponds to a particular type of INTRA macroblock. If it is determined in step S509 that the current block is an I_PCM macroblock type, the coded sample values of current are successively decoded in step S510 and then the macroblock is marked as non ILP_LOST. In case of an INTRA or INTER macroblock, the next step involves decoding the prediction data of current macroblock in step S513 or S512, depending on the macroblock splitting configuration. These prediction data decoding steps S513 or S512 according to an embodiment of the invention are represented in FIG. 13.

Subsequent step S514 of the algorithm of FIG. 11 involves testing if the current macroblock contains at least one non-zero quantized transform coefficient. If so, then the texture residual data associated with the current macroblock is decoded in step S515, according to the SVC specification. Once the macroblock residual data has been processed, the current macroblock is marked as “non ILP_LOST” in step S516.

Subsequent step S517 then checks whether or not the end of current coded slice has been reached. If so, the algorithm of FIG. 11 comes to an end in step S518. Otherwise, the algorithm returns to the macroblock skip flag decoding step S502 at the beginning of the algorithm.

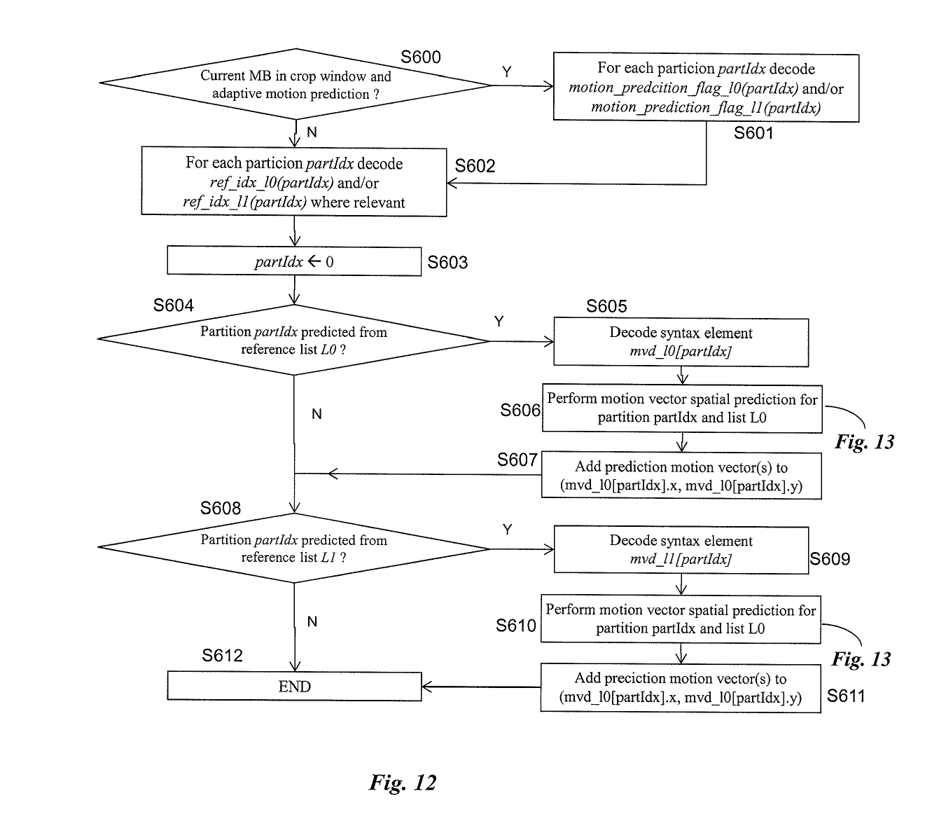

FIG. 12 depicts the algorithm used to decode the prediction data associated with a coded macroblock of an enhancement slice, according to an embodiment of the present invention.

The input to this algorithm comprises the current macroblock to be decoded. The algorithm first tests in step S600 if the current macroblock is located inside the crop window associated with the current image. If it is determined that the current macroblock is within the crop window, this means that current macroblocks have a co-located macroblock in the reference layer (or base layer) used for the inter-layer prediction of the current scalability layer. If the test is positive, then the algorithm decodes in step S601 the flags “motion_prediction_flag_I0” and “motion_predicition_flag_I1” associated with each partition contained in the current macroblock. These flags indicate whether or not inter-layer motion refinement is applied to the motion vector derived from the base layer through inter-layer prediction, respectively for motion field linked to the L0 and L1 reference picture lists.

In step S602 decoding of the index (indices) that identifies the reference picture(s) used to temporally predict each partition of current macroblock is performed.

The following part of the algorithm performs a loop on the partitions contained in current macroblock. The first partition is indexed in step S603. For each partition successively considered, the following steps are applied.

In step S604 the algorithm checks if the current partition is predicted from a reference picture contained in reference picture list L0. If this is the case, the syntax element mvd_I0 associated with the current partition is decoded in step S605. This syntax element corresponds to motion vector residual data, to be added to a motion vector predictor for reconstructing the current partition's motion vector. This motion vector prediction value is computed in subsequent step S606 of the algorithm according to the method described with reference to FIG. 13. The next step S607 of the algorithm of FIG. 12 is to reconstruct the current partition's motion vector, by adding the current motion vector residual to the motion vector predictor obtained from the algorithm of FIG. 13. Otherwise, if it is determined in step S604 that the current partition is not predicted from a reference picture contained in reference picture list L0, the process proceeds directly to step S608.

The next step S608 (after step S607 or S604) checks if the current partition is temporally predicted from a picture in the L1 reference picture list. If so, then the same motion vector prediction, residual decoding and reconstruction steps as those previously mentioned are performed in steps S609 to S611. Otherwise the process proceeds directly to end step S612.

Once the current motion information of current macroblock partition has been decoded, it is determined if the current partition is the last one in the current macroblock. If this is the case, then the algorithm of FIG. 12 ends in step S612. Otherwise, the algorithm re-iterates the motion information decoding process on the next partition of current macroblock.

FIG. 13 illustrates steps of a spatial prediction process that is applied in accordance with an embodiment of the invention, to INTER macroblocks in enhancement slices. The illustrated algorithm is executed during step S512 or step S513 of the SVC slice decoding process of FIG. 11, which aims at reconstructing enhancement layer macroblocks, before application of the deblocking filter. More precisely, the motion vector spatial prediction process of FIG. 13 is launched by the algorithm of FIG. 12, in steps S606 and S610. Therefore, at this stage of the overall enhancement picture decoding process, the parsing step introduced with reference to FIG. 2 has already been performed.

The input to this algorithm is the current macroblock being decoded and the partition currently being processed inside that macroblock.

The algorithm starts in step S701 by testing if the left neighbour of a current macroblock has been lost. The result of this test is then stored as a variable is_lost_a. If the test of step S701 is negative, then this indicates the macroblock partition on the left of the current macroblock partition has been received. Consequently, the value of the motion vector of the left partition and the associated reference picture index are obtained in step S702. They are respectively noted mv_a and ref_idx_a.

Next in step S703, a similar test is performed on the top neighbouring macroblock b of the current macroblock. If the top neighbouring macroblock has been received, the corresponding motion vector value mv_b and reference picture index ref_idx_b are obtained in step S704.

Next in step S705 a similar test is performed on the top-right neighbouring macroblock c of the current macroblock, which leads to motion vector value mv_c and reference picture index ref_idx_c in case of a correctly received macroblock being obtained in step S706.

Subsequent step S707 consists in determining if all three neighbouring macroblocks a, b and c have been correctly received. If that is the case, then the value of the motion vector of current macroblock partition is calculated in step S708 as the median value of the mv_a, mv_b and mv_c motion vectors previously obtained. Once this is done, the algorithm of FIG. 11 comes to an end.

If the test was negative and it is determined that all three neighbouring macroblocks a, b and c have not been correctly received, then the algorithm verifies in step S709 if the current macroblock has left, top and top-right neighbouring macroblocks available inside the current slice. If not, the current macroblock is marked as lost in step S711 and the algorithm ends. If the test is positive, then it is determined in step S710 if exactly one macroblock from among neighbouring macroblocks a, b and c has been marked as MB_LOST. If this is not the case then the current macroblock is marked as lost in step S711 and the algorithm of FIG. 13 ends.

Otherwise, it is determined in step S712 which macroblock among a, b, and c is the lost macroblock. When the lost macroblock is identified, it is determined if the two remaining neighbours have equal motion vector values. If so, then the motion vector predictor value of the current partition is set to be equal to that of the two received neighbours. In order to obtain the motion vector value for the current partition, the motion vector predictor value is added to the motion vector residual value encoded in the bitstream (step S607 or S610). If not, then current macroblock is marked as MB_LOST.

Embodiments of the invention thus lead to an improvement with respect to methods of the prior art, since fewer macroblocks are marked as lost compared to before. These improvements can be obtained in particular case where pictures contain multiple slices, and some losses occur in non-uppermost layer(s), and inter-layer prediction of motion vector is employed between the lost slices and some uppermost macroblocks.

Although the present invention has been described hereinabove with reference to specific embodiments, the present invention is not limited to the specific embodiments, and modifications will be apparent to a skilled person in the art which lie within the scope of the present invention.

Many further modifications and variations will suggest themselves to those versed in the art upon making reference to the foregoing illustrative embodiments. In particular the different features from different embodiments may be interchanged, where appropriate.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A method of decoding a bitstream of encoded video data comprising a plurality of coding units, the method comprising:
receiving the encoded video data;
determining coding units missing from the received encoded video data;
identifying further coding units dependent, for decoding according to a spatial prediction process, on the coding units determined as missing;
treating a further coding unit of the identified further coding units as not being missing in the case where a majority of the coding units on which it is dependent have been received and provide equal predictor values for the spatial prediction process,
otherwise treating the further coding unit as missing.

2. A method according to claim 1 wherein the step of determining coding units missing from the received encoded video data comprises determining slices of data missing from the received encoded data and determining the missing coding units based on the slices determined as missing.

3. A method according to claim 1 further comprising setting a spatial predicted value of the further coding unit treated as not missing to the equal predictor value provided by the two coding units on which the further coding unit is dependent

4. A method according to claim 1 performed during a syntactic decoding process.

5. A method according to claim 1 wherein the predictor value comprises a motion vector value for a motion vector prediction process.

6. A method according to claim 1 further comprising performing an error concealment process on the coding units and further coding units marked as missing.

7. A method according to claim 1 wherein the video data has been encoded according to a scalable video coding process and comprises a plurality of scalable layers wherein inter-layer dependencies between coding units are taken into account when identifying further coding units dependent on a missing coding unit.

8. A method according to claim 1 further comprising selecting a scalability layer for decoding based on the coding units detected as missing.

9. A decoding device for decoding a bitstream of encoded video data comprising a plurality of coding units, the decoding device comprising:
a receiver for receiving the encoded video data; and
a processor configured to
determine coding units missing from the received encoded video data;
identify further coding units dependent, for decoding according to a spatial prediction process, on the coding units determined as missing; and
treat a further coding unit of the identified further coding units as not being missing in the case where a majority of coding units on which it is dependent have been received and provide equal predictor values for the spatial prediction process, otherwise marking the further coding unit as missing.

10. A device according to claim 9 wherein the processor is configured to determine slices of data missing from the received encoded data and to determine the missing coding units based on the slices determined as missing.

11. A device according to claim 9 further comprising a value setting module configured to set a spatial predicted value of the further coding unit treated as not missing to the equal predictor value provided by the two coding units on which the further coding unit is dependent.

12. A device according to claim 9 operable to perform during a syntactic decoding process.

13. A device according to claim 9 wherein the predictor value comprises a motion vector value for a motion vector prediction process.

14. A device according to claim 9 further comprising an error concealment module configured to perform an error concealment process on the coding units and further coding units marked as missing.

15. A device according to claim 9 wherein the video data has been encoded according to a scalable video coding process and comprises a plurality of scalable layers wherein inter-layer dependencies between coding units are taken into account by the means for identifying further coding units dependent on a missing coding unit.

16. A device according to claim 9 further comprising a selector for selecting a scalability layer for decoding based on the coding units detected as missing.

17. A computer-readable storage medium storing instructions of a computer program for implementing a method, according to claim 1.
